(19) United States
(12) Patent Application Publication
(10) Pub. No.: US 2004/0242062 A1
(43) Pub. Date: Dec. 2, 2004

(54) Methods and apparatus for managing cables and cable connectors

(76) Inventors: Karin R. Hughes, Wheaton, IL (US); Karl B. Randall, Lockport, IL (US)

Correspondence Address: Cheryl F. Benes, Tellabs Operations, Inc., 1415 West Diehl Road, Naperville, IL, 60563, US

(21) Appl. No.: 10/452,742

(22) Filed: Jun. 2, 2003

(51) Int. Cl. H01R 13/60

(52) U.S. Cl. 439/540.1

(57) ABSTRACT

Methods and apparatus for managing cables and cable connectors include the use of a first cable jack having a first height and second cable jack adjacent to the first cable jack and having a second height that is different than the first height of the first cable jack. Methods and apparatus for managing cables and cable connectors also include the use of a first cable plug having a first height and a second cable plug adjacent to the first cable plug and having a second height that is different than the first height of the first cable plug. In these various ways, the present invention contemplates a first cable connector assembly having a first height and a second cable connector assembly adjacent to the first cable connector assembly and having a second height that is different that the first height of the first cable connector assembly.

### FIELD OF THE INVENTION

The present invention relates to cable management and includes methods and apparatus for the effective and efficient management of cables and connectors therefor.

### BACKGROUND OF THE INVENTION

An industry standard BNC (British Navel Connector, Bayonet Nut Connector, or Bayonet Neill-Concelman) plug (or male connector) is a known bayonet-style twist-locking connector for coaxial cables. The BNC plug mates with and secures to an industry standard BNC jack (or female connector) typically via a rotatable collar (or bayonet coupling nut) on the BNC plug, that rotates for example ¼ turn in the connection or disconnection of the BNC plug with the BNC jack to make a BNC connector assembly. (The arrangement of a jack (not necessarily of BNC type) and its corresponding plug (not necessarily of BNC type) is hereinafter referred to as a cable connector assembly.) A typical application for a BNC connector assembly is to provide interconnection between a cable and a backplane of an equipment shelf.

In applications where a high-density of BNC connector assemblies (e.g. 1 inch or less center-to-center spacing between adjacent connector assemblies each having a width of about 0.5 inch each) is required, such as for example on a backplane of an equipment shelf, multiple challenges are often encountered. One challenge is that sufficient clearance surrounding a particular BNC connector assembly is required to install, remove and maintain the BNC connector assembly. For example, a high-density arrangement of BNC connector assemblies on a backplane can make it difficult, if not impossible, to readily and effectively access the rotatable collars of the BNC plugs of the BNC connector assemblies to connect or disconnect the BNC plugs from their corresponding BNC jacks. A standard tool or fingers used to connect or disconnect a BNC plug with its corresponding BNC jack can require a measure of clearance surrounding the rotatable collar of the BNC plug during connection or disconnection. A high-density arrangement of BNC connector assemblies may not permit such clearance.

Another challenge arises in an arrangement of BNC connector assemblies after cables are connected to each of the BNC plugs of the BNC connector assemblies. If the cables are not neatly “dressed”, routed between the BNC connector assemblies, secured or otherwise managed, the cables may impede access to the BNC connector assemblies because they may block access to the rotatable collars on the BNC plugs of the BNC connector assemblies. Furthermore, if the cables are not managed well and as a result are put under tension or strain, the signals transmitted through the cables to the connecting equipment may be adversely affected. Thus, a measure of clearance surrounding a particular BNC connector assembly could provide space to organize and manage the cables connected to the BNC connector assemblies.

Prior approaches for managing BNC connector assemblies and associated cables have limitations. One approach replaces a high-density arrangement of BNC connector assemblies with a lower-density arrangement. However, this approach may not be practical or feasible for a particular application because the application may not permit such a lower-density arrangement of BNC connector assemblies. For example, a particular application could require a certain number of BNC connector assemblies on a backplane having a finite area. Moreover, a lower-density arrangement of BNC connector assemblies may be undesirable because it will likely increase the number or size of backplanes used for a particular application and furthermore increase a product's “footprint” or floor space consumed.

Another approach to accessing a particular BNC connector assembly, for maintenance, testing or other access activities, is to disconnect the nearby BNC connector assemblies and cables, perform the access activity on the particular BNC connector assembly and then reconnect the nearby BNC connector assemblies and cables. This approach is not desirable because it can temporarily disrupt the operation of active (e.g. traffic bearing) equipment and otherwise can be labor intensive.

### SUMMARY OF THE INVENTION

Methods and apparatus for managing cables and cable connectors include, in one aspect of the invention, the use of a first cable jack having a first height and second cable jack adjacent to the first cable jack and having a second height that is different than the first height of the first cable jack. Methods and apparatus for managing cables and cable connectors also include, in another aspect of the invention, the use of a first cable plug having a first height and a second cable plug adjacent to the first cable plug and having a second height that is different than the first height of the first cable plug. In these various ways, the present invention contemplates a first cable connector assembly having a first height and a second cable connector assembly adjacent to the first cable connector assembly and having a second height that is different that the first height of the first cable connector assembly.

### DESCRIPTION OF THE DRAWINGS

The present invention is illustrated by way of example and not by way of limitation in the figures of the accompanying drawings, in which like references indicate similar elements and wherein:

FIG. 1A shows a side view of a cable jack having a first height, according to an exemplary embodiment of the present invention;

FIG. 1B shows an end view of the cable jack shown in FIG. 1A;

FIG. 2A shows a side view of a cable jack having a second height that is different than the height of the cable jack shown in FIG. 1A, according to an exemplary embodiment of the present invention;

FIG. 2B shows an end view of the cable jack shown in FIG. 2A;

FIG. 3A shows a perspective view of exemplary embodiment cable connector assemblies;

FIG. 3B shows a side view of the cable connector assemblies shown in FIG. 3A;

FIG. 4A shows a side view of a cable plug, according to an exemplary embodiment of the present invention;

FIG. 4B shows an end view of the cable plug shown in FIG. 4A;

FIG. 5 shows a perspective view of further exemplary embodiment cable connector assemblies; and

FIG. 6 shows a side view of exemplary embodiment cable connector assemblies.

### DETAILED DESCRIPTION

Cable applications often require a particular density of cable connector assemblies or limit the amount of space between a cable connector assembly and another. For example, a given application may require one inch center-to-center spacing between two adjacent cable connector assemblies, each cable connector assembly having a width of about 0.5 inch. The present invention can be used to help meet an application requirement that calls for a relatively high density of an arrangement of cable connector assemblies. In addition, the present invention can allow a finger or tool to more readily access cable connector assemblies as compared to existing approaches. Furthermore, the present invention can be used to better organize and manage cables associated with cable connector assemblies as compared to existing cable connector assembly arrangements.

An exemplary embodiment of the present invention comprises a first cable jack having a first height and a second cable jack adjacent to the first cable jack and having a second height that is different than the height of the first cable jack. The arrangement of such first and second adjacent cable jacks is hereinafter referred to as a cable jack pair. The benefits of using a cable jack pair can be readily realized when the cable jack pair is placed, for example, in arrangement on a backplane of an equipment shelf, such as for example an equipment shelf in a node of a communication network. After adjacent cable jacks having different heights relative to each other are presented on a backplane, when cable plugs are connected to the cable jacks, the rotatable collars of the cable plugs are positioned at different heights relative to each other, so long as the cable plugs do not differ from each other in height by an amount equal to the height difference between the respective jacks. Furthermore, the rotatable collars (or other connection and disconnection mechanisms) on the cable plugs are in turn positioned at different heights relative to each other, improving the clearance surrounding the rotatable collars as compared to prior approaches. Therefore, as a result of this positioning of the cable plugs, access by a finger or a tool to the rotatable collars on the cable plugs, for connection or disconnection with the cable jacks, is improved as compared to prior art approaches.

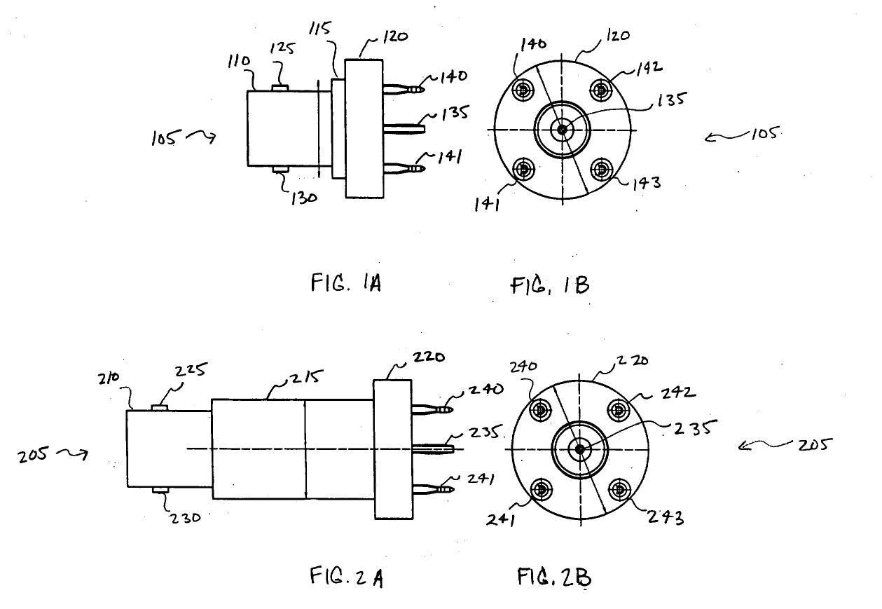

FIGS. 1A and 1B show an exemplary embodiment first cable jack. Body 105, having a sleeve 110, a middle section 115 and a base 120, has a total height of 0.697 inch. Base 120 has a diameter of 0.699 inch. Attached to sleeve 110 are a pair of diametrically opposed engagement pins 125 and 130 that extend radially outward from the sleeve. Attached to base 120 is a center conductor 135 adapted to be received by a conductive receptacle on the backplane of an equipment shelf. Also attached to base 120 are press fit pins 140-143 adapted to be received by receptacles on the backplane of an equipment shelf.

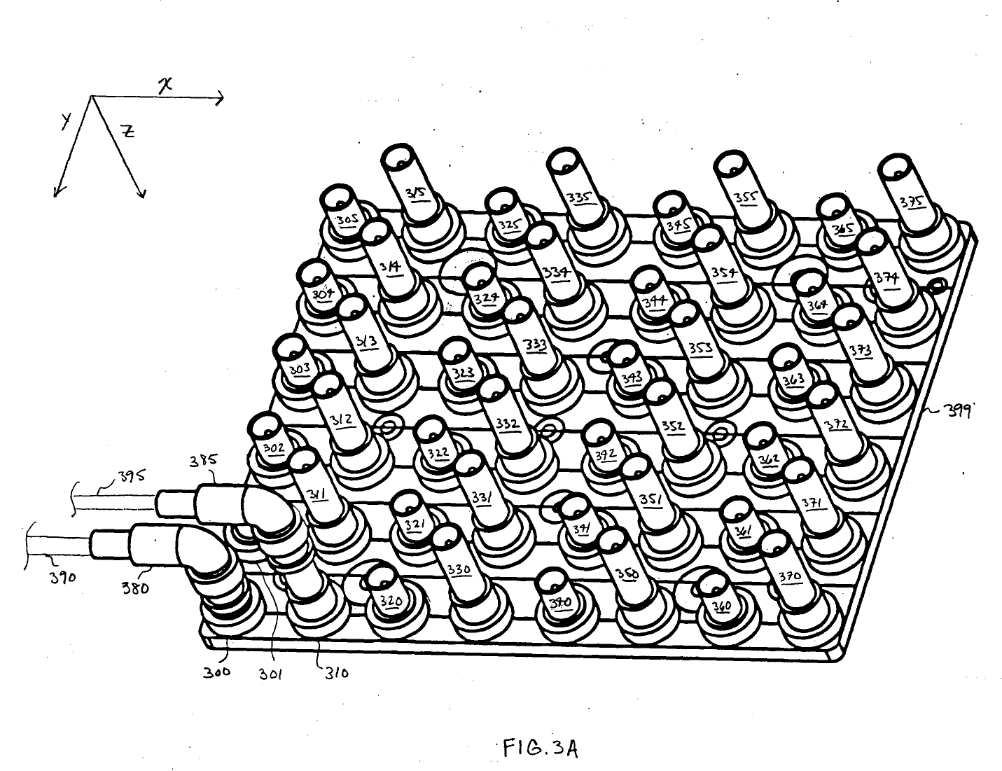

FIGS. 2A and 2B show an exemplary embodiment second cable jack. Body 205, having a sleeve 210, a middle section 215 and a base 220, has a total height of 1.455 inches. Base 220 has a diameter of 0.699 inch. Attached to sleeve 210 are a pair of diametrically opposed engagement pins 225 and 230 that extend radially outward from the sleeve. Attached to base 220 is a center conductor 235 adapted to be received by a conductive receptacle on the backplane of an equipment shelf. Also attached to base 220 are press fit pins 240-243 adapted to be received by receptacles on the backplane of an equipment shelf.

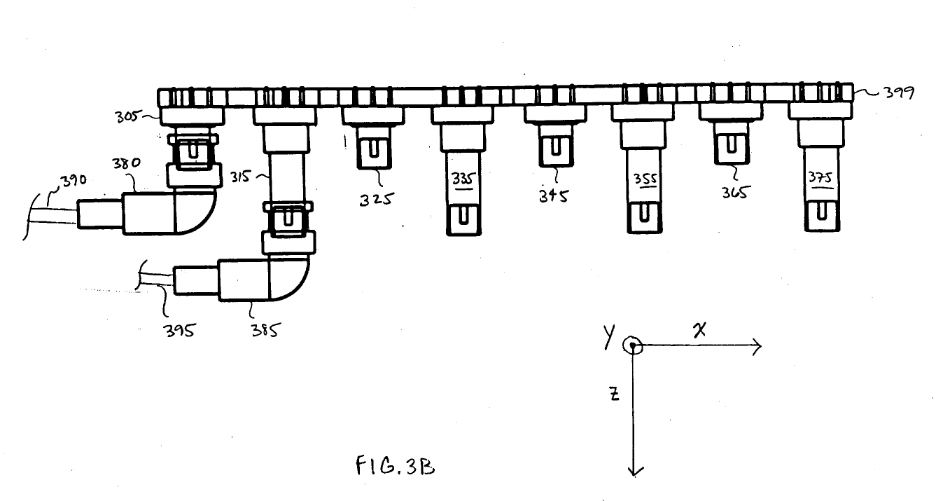

By connecting a cable plug to either the first cable jack shown in FIGS. 1A and 1B or the second cable jack shown in FIGS. 2A and 2B, an exemplary cable connector assembly can be made. FIGS. 3A and 3B show such cable connector assemblies. The cable jack of FIGS. 1A and 1B is shown in FIGS. 3A and 3B as cable jack 300, connected to a cable plug 380 to make a cable connector assembly 381. The cable jack of FIGS. 2A and 2B is shown in FIGS. 3A and 3B as cable jack 310, connected to cable plug 385 to make another cable connector assembly 386.

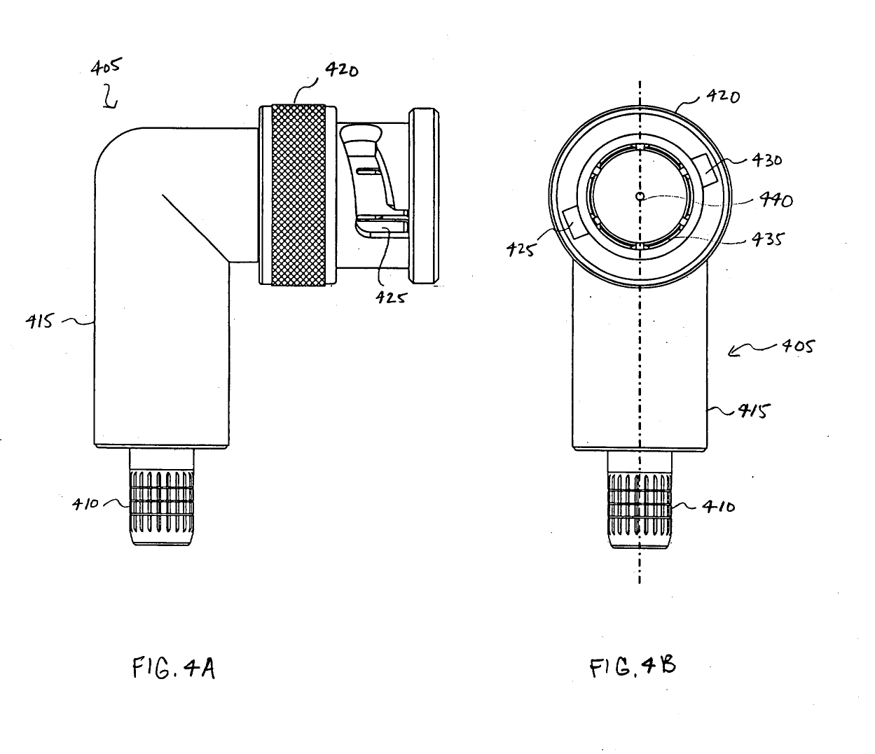

Cable plugs 380 and 385 are identical in size and shape in this exemplary embodiment. They are shown in further detail in FIGS. 4A and 4B. Body 405 has a sleeve 410 adapted to receive a cable, an elbow-shaped middle section 415 and a rotatable collar 420. Sleeve 410 and adjacent portion of middle section 415 have a total length of 1.32 inches (delineated by bracket 411). Rotatable collar 420 and adjacent portion of middle section 415 have a total height of 1.10 inches (delineated by bracket 421) and rotatable collar has a diameter of 0.593 inch. Rotatable collar 420 has diametrically opposed engagement slots 425 and 430 and a center terminal 435 which has a center conductor 440.

To make an exemplary embodiment cable connector assembly, the cable plug of FIGS. 4A and 4B is engaged with the cable jack shown in FIGS. 1A and 1B as follows. First, engagement pins 125 and 130 of the cable jack are inserted into engagement slots 425 and 430 of the cable plug. Next, sleeve 110 of the cable jack slides over center terminal 435 of the cable plug. Rotatable collar 420 is then rotated ¼ turn clockwise to lock the cable plug onto the cable jack. The cable plug of FIGS. 4A and 4B can be engaged with the cable jack shown in FIGS. 2A and 2B in a similar manner.

In an opposite manner, the cable plug of FIGS. 4A and 4B can be disengaged with the cable jack shown in FIGS. 1A and 1B as follows. First, rotatable collar 420 is rotated ¼ turn counter-clockwise to unlock the cable plug from the cable jack. Next, sleeve 110 of the cable jack slides off center terminal 435 of the cable plug while engagement pins 125 and 130 of the cable jack slide through engagement slots 425 and 430 of the cable plug. Similarly, the cable plug of FIGS. 4A and 4B can be disengaged with the cable jack shown in FIGS. 2A and 2B.

FIGS. 3A and 3B illustrate how the present invention can improve access to the assemblies and organization of the associated cables, when compared to existing approaches, by showing cable connector assemblies of various heights (that use cable jack pairs having cable jacks of various heights). Cable jacks 300 and 310 are each connected to backplane 399. Cable jack 300 has a first height and adjacent cable jack 310 has a second height that is different than the height of cable jack 300. The two cable jacks form an exemplary cable jack pair. Connected to cable jacks 300 and 310 are identical 90-degree elbow-shaped cable plugs 380 and 385 and connected to the plugs are cables 390 and 395 respectively. Because cable jacks 300 and 310 have different heights relative to each other, when corresponding cable plugs 380 and 385 are connected to them, the rotatable collars on the cable plugs are positioned along the z-axis at different heights relative to each other. Cables 390 and 395, connected to cable plugs 380 and 385, are in turn positioned along the z-axis at different heights relative to each other. The positioning of the cable plugs along the z-axis in this way improves the clearance surrounding the rotatable collars of the cable plugs and thus improves access to the collars as compared to prior art approaches. Similarly, the positioning of the associated cables along the z-axis in this way helps relieve congestion of cables typically found to prior approaches and provides room to better manage and organize the cables. Furthermore, the rigid elbow shape of the cable plugs helps maintain the positioning of the flexible cables which helps in the management of the cables.

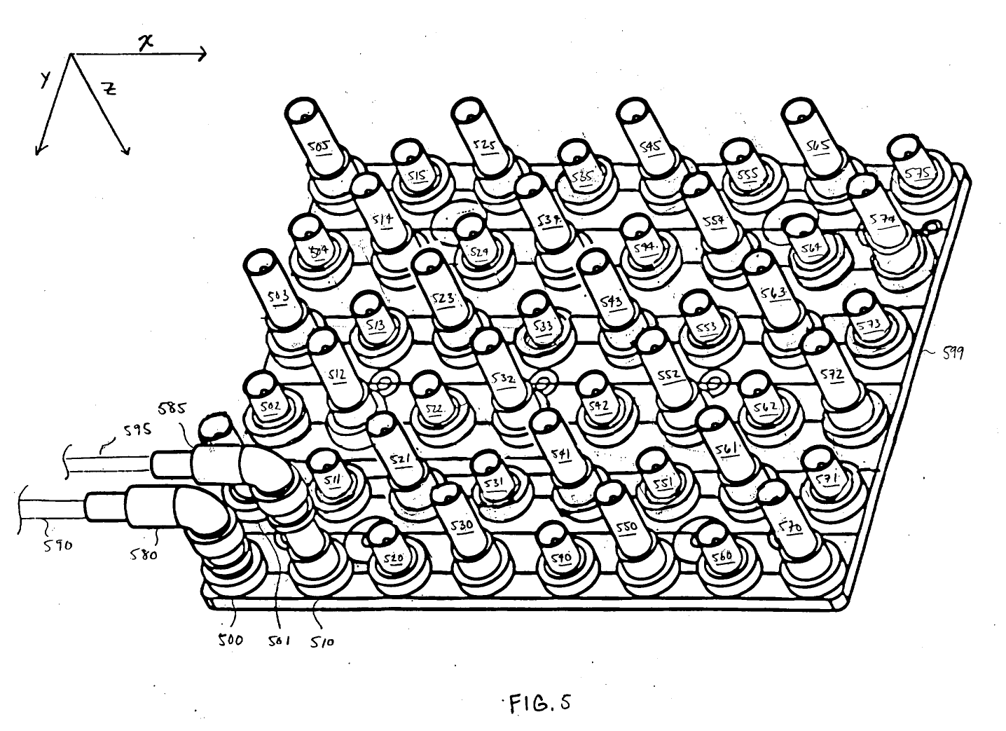

An adjacent cable jack can be added to a cable jack pair to form a substantially linear arrangement hereinafter referred to as a cable jack string. FIGS. 3A, 3B and 5 illustrate exemplary embodiments of a cable jack string. For example in FIGS. 3A and 3B, cable jacks 305, 315 and 325 form a cable jack string (cable jack string 1), wherein the cable jack pair of the cable jack string can be either cable jack pair 305 and 315 or cable jack pair 315 and 325. Cable jacks 305, 314 and 323 form another cable jack string (cable jack string 2), wherein the cable jack pair of the cable jack string can be either cable jack pair 305 and 314 or cable jack pair 314 and 323. In FIG. 5, cable jacks 575, 574 and 573 form a cable jack string (cable jack string 3), wherein the cable jack pair of the cable jack string can be either cable jack pair 575 and 574 or cable jack pair 574 and 573. Furthermore, cable jacks 574, 573 and 572 form a cable jack string (cable jack string 4), wherein the cable jack pair of the cable jack string can be either cable jack pair 574 and 573 or cable jack pair 573 and 572. In these embodiments, cable plugs of the same height relative to each other, or of two or more varying relative heights, may be connected to the cable jacks to make resultant cable connector assemblies of various heights.

One or more additional cable jacks can be added to a cable jack string to form a substantially linear arrangement hereinafter referred to as a cable jack row. For example, in FIG. 3A, a cable jack row (cable jack row 1) is formed by adding to cable string 1 the following cable jacks: 335, 345, 355, 365 and 375. Another cable jack row (cable jack row 2) is formed by adding to cable jack string 2 the following cable jacks: 332, 341 and 350. In FIG. 5, a cable jack row (cable jack row 3) is formed by adding to cable jack string 3 the following cable jacks: 572, 571 and 570. Another cable jack row (cable jack row 4) is formed by adding to cable jack string 4 the following cable jacks: 575, 571 and 570. In these embodiments, cable plugs of the same height relative to each other, or of two or more varying relative heights, may be connected to the cable jacks to make result cable connector assemblies of various heights.

In addition, FIG. 3A illustrates an exemplary embodiment of multiple cable jack rows to make an arrangement hereinafter referred to as a cable jack array. In FIG. 3A, an exemplary embodiment cable jack array is formed from combining the cable jack row 1 and adjacent cable jack row comprising cable jacks 304, 314, 324, 334, 344, 354, 364 and 374 (cable jack row 1′). In a cable jack array, each cable jack row has an identical order of cable jacks. For example, cable jack row 1 and cable jack row 1′ identically order their cable jacks (each cable jack having a cable jack of a first height (cable jack 1) and a cable jack of a second height (cable jack 2)) with the pattern: cable jack 1, cable jack 2, cable jack 1, cable jack 2, cable jack 1, cable jack 2, cable jack 1, cable jack 2. To make cable connector assemblies, cable plugs of the same height or of two or more various heights can be connected to the cable jacks to make resultant cable connector assemblies of various heights.

FIG. 5 illustrates an exemplary embodiment of multiple rows of cable jacks to make an arrangement hereinafter referred to as a checkered cable jack array. In FIG. 5, an exemplary embodiment checkered cable jack array is formed from combining the cable jack row comprising cable jacks 505, 515, 525 535, 545 555, 565 and 575 (cable jack row 5) and adjacent cable jack row comprising cable jacks 504, 514, 524, 534, 544, 554, 564 and 574 (cable jack row 5′). In a checkered cable jack array, the cable jacks of the second adjacent cable jack row are ordered relative to a first cable jack row or column to make a checkered pattern with the two cable jack rows. For example, cable jack row 5 orders its cable jacks in the pattern: cable jack 2, cable jack 1, cable jack 2, cable jack 1, cable jack 2, cable jack 1, cable jack 2, cable jack 1. The cable jacks of adjacent cable jack row 5′ are ordered relative to the order of row 5 as follows: cable jack 1, cable jack 2, cable jack 1, cable jack 2, cable jack 1, cable jack 2, cable jack 1, cable jack 2. To make cable connector assemblies, cable plugs of the same height or of two or more various heights can be connected to the cable jacks to make resultant cable connector assemblies of various heights.

FIGS. 3A and 5 further illustrate exemplary embodiments of two arrangements, hereinafter referred to as a cable jack quadrate and a checkered cable jack quadrate, that each use two identical cable jack pairs substantially arranged to form a square shape. Both the cable jack quadrate and the checkered cable jack quadrate position the four cable jacks of the two cable jack pairs at the four vertices of the square shape. However, the cable jack quadrate positions the cable jacks having a first height at adjacent vertices and positions the cable jacks having a second height at the remaining vertices. In contrast, the checkered cable jack quadrate forms a checkered pattern by positioning the cable jacks having a first height at opposite vertices and positioning the cable jacks having a second height at the remaining vertices. A cable jack quadrate (cable jack quadrate 1) is illustrated in FIG. 3A by the cable jacks 305, 315, 304 and 314, wherein cable jacks 305 and 304 are cable jacks having a first height positioned at adjacent vertices and cable jacks 315 and 314 are cable jacks having a second height positioned at the remaining vertices. A checkered cable jack quadrate (checkered cable jack quadrate 1) is illustrated in FIG. 5 by the arrangement of cable jacks 505, 515, 504 and 514, where cable jacks 504 and 515 are cable jacks having a first height positioned at opposite vertices and cable jacks 505 and 514 are cable jacks having a second height positioned at the remaining vertices. To make cable connector assemblies, cable plugs of the same height relative to each other, or of two or more varying relative heights, can be connected to the cable jacks to make resultant cable connector assemblies of various heights.

Instead of using multiple cable jack rows to form a cable jack array or checkered cable jack array, multiple cable jack quadrates can be used to form a cable jack array and multiple checkered cable jack quadrates can be used to form a checkered cable jack array. For example, in FIG. 3A, a cable jack quadrate, comprising the cable jacks 325, 335, 324, and 334, can be added to cable jack quadrate 1 to from a cable jack array. In FIG. 5, a checkered cable jack quadrate, comprising the cable jacks 525, 535, 524 and 534, can be added to checkered cable jack quadrate 1 to form a checkered cable jack array. To make cable connector assemblies, cable plugs of the same height relative to each other, or of two or more varying relative heights, can be connected to the cable jacks to make resultant cable connector assemblies of various heights.

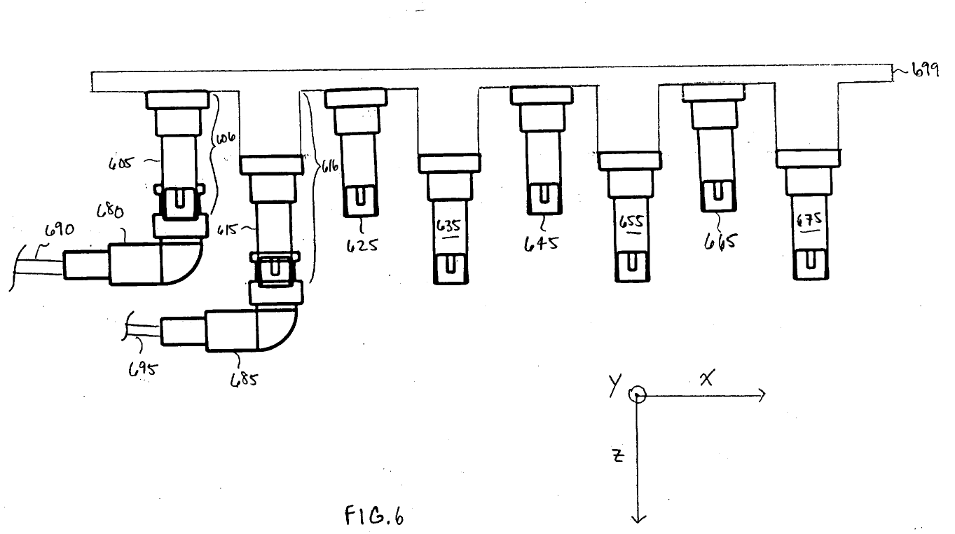

The cable jack pairs used in the above described exemplary embodiments may be varied by using cable jacks having a first or second height that is an effective first or second height instead of a physical first or second height. FIG. 6 illustrates this exemplary embodiment. Cable jacks 605 and 615, identical and size and shape in this exemplary embodiment, are each connected to support structure 699, such as a backplane. Cable jack 605 has a first height (delineated by bracket 606) that is a physical height and adjacent cable jack 616 has a second height (delineated by bracket 616) that is an effective height and is different than the height of cable jack 605. The effective height of cable jack 616 is created by adding the physical height of cable jack 615 and the physical height of an adjacent portion of the support structure 699. The two cable jacks 605 and 615 form an exemplary cable jack pair and yield the same effect as a cable jack pair made of cable jacks having first and second heights that are physical.

Furthermore, the above described exemplary embodiments may be varied by using cable plugs instead of cable jack. For example, a first cable plug having a first (physical or effective) height and an adjacent second cable plug having a second (physical or effective) height that is different than the height of the first cable plug makes an arrangement hereinafter referred to as a cable plug pair. Another exemplary embodiment comprises a substantially linear arrangement of a cable plug pair and an adjacent cable plug, to make an arrangement hereinafter referred to as a cable plug string. Additional cable plugs can be added to a cable plug string to form a substantially linear arrangement hereinafter referred to as a cable plug row. Yet another exemplary embodiment comprises multiple cable plug rows to make an arrangement hereinafter referred to as a cable plug array. In a cable plug array, each cable plug row has an identical order of cable plugs. Alternatively, an arrangement hereinafter referred to as checkered cable plug array can be made by ordering a first cable plug row in a particular pattern and ordering an adjacent second cable pair row relative to the first cable plug row to make a checkered pattern with the two cable plug rows. A cable plug quadrate and a checkered cable plug quadrate can be formed by substantially arranging two identical cable plug pairs at the four vertices of a square shape; the cable plug quadrate positions the cable plugs having a first height at adjacent vertices and positions the cable jacks having a second height at the remaining vertices while the checkered cable plug quadrate forms a checkered pattern by positioning the cable plugs having a first height at opposite vertices and positioning the cable plugs having a second height at the remaining vertices. In these embodiments, cable jacks of the same height relative to each other, or of two or more varying relative heights, may be connected to the cable plugs to make resultant cable connector assemblies of various heights.

Through both the cable jack and cable plug embodiments, the present invention contemplates a first cable connector assembly having a first height and a second cable connector assembly adjacent to the first cable connector assembly and having a second height that is different that the first height of the first cable connector assembly. Because the cable plug embodiments position the cables associated with the cable connector assemblies at varying relative heights, the cable plug embodiments improve upon prior approaches by providing room for cable management. Because the cable jack embodiments position the rotable collars of the cable plugs at varying relative heights, the cable jack embodiments improve access to the rotatable collars of the cable connector assemblies, in addition to providing room for cable management, as compared to prior approaches.

In the foregoing description, the invention is described with reference to specific exemplary embodiments thereof. It will, however, be evident that various modifications and changes may be made thereto, without departing from the broader spirit and scope of the present invention. The present invention can be demonstrated in various embodiments. First, the present invention may be used for any type of cable connection application, including without limitation coaxial cable, twisted pair copper wire, side-by-side wire, ribbon wire, or optical fiber cable. Further, any type of cable connectors or connector combinations may be used, including without limitation, using elbow cable connectors at any degree, 180-degree cable connectors or combinations of cable connectors of various degrees. Moreover, the heights of the cable connector assemblies can be substantially arranged in any shape or arrangement or multiple shapes or arrangements to accommodate a particular application and/or space constraints. In addition, more than two different heights of a cable connector assembly can be used throughout an arrangement. Finally, cable connector assemblies may be substantially arranged by groups, non-linear arrangements, linear arrangements in a diagonal, vertical, horizontal or other direction, or concentric shapes of alternating, ascending, descending or otherwise different heights. Because of the various possible configurations of the present invention, the specification and drawings are to be regarded in an illustrative rather than in a restrictive sense.

What is claimed is:

1. A cable connector arrangement comprising:
a first cable jack having a first height; and
a second cable jack adjacent to the first cable jack and having a second height that is different than the first height.

2. The cable connector arrangement of claim 1, further comprising:
a third cable jack, wherein the first, second and third cable jacks are substantially arranged in a first linear arrangement.

3. The cable connector arrangement of claim 2, wherein the third cable jack has the first height.

4. The cable connector arrangement of claim 2, wherein the third cable jack has the second height.

5. The cable connector arrangement of claim 1, further comprising:
a first cable plug connected to the first cable jack; and
a second cable plug connected to the second cable jack.

6. The cable connector arrangement of claim 2, further comprising:
a third cable plug connected to the third cable jack.

7. The cable connector arrangement of claim 5, wherein the first cable plug is elbow-shaped.

8. The cable connector arrangement of claim 5, wherein the second cable plug is elbow-shaped.

9. The cable connector arrangement of claim 6, wherein the third cable plug is elbow-shaped.

10. A cable connector arrangement comprising:
a first cable plug having a first height; and
a second cable plug adjacent to the first cable plug and having a second height that is different than the first height.

11. The cable connector arrangement of claim 10, further comprising:
a third cable plug, wherein the first, second and third cable plugs are substantially arranged in a first linear arrangement.

12. The cable connector arrangement of claim 11, wherein the third cable plug has the first height.

13. The cable connector arrangement of claim 11, wherein the third cable plug has the second height.

14. The cable connector arrangement of claim 10, further comprising:
a first cable jack connected to the first cable plug; and
a second cable jack connected to the second cable plug.

15. The cable connector arrangement of claim 11, further comprising:
a third cable plug connected to the third cable jack.

16. The cable connector arrangement of claim 14, wherein the first cable plug is elbow-shaped.

17. The cable connector arrangement of claim 14, wherein the second cable plug is elbow-shaped.

18. The cable connector arrangement of claim 15, wherein the third cable plug is elbow-shaped.

19. A cable connector arrangement comprising:
a first cable jack pair;
a second cable jack pair; wherein the first and second cable jack pairs are substantially arranged to form a square shape.

20. The cable connector arrangement of claim 19, wherein a first cable jack of the first cable jack pair and a first cable jack of the second cable jack pair are positioned at adjacent vertices of the square shape.

21. The cable connector arrangement of claim 19, wherein a first cable jack of the first cable jack pair and a first cable jack of the second cable jack pair are positioned at opposite vertices of the square shape.

22. A cable connector arrangement comprising:
a first cable plug pair;
a second cable plug pair; wherein the first and second cable plug pairs are substantially arranged to form a square shape.

23. The cable connector arrangement of claim 22, wherein a first cable plug of the first cable plug pair and a first cable plug of the second cable plug pair are positioned at adjacent vertices of the square shape.

24. The cable connector arrangement of claim 22, wherein a first cable plug of the first cable plug pair and a first cable plug of the second cable plug pair are positioned at opposite vertices of the square shape.
